(19) United States
(12) Patent Application Publication
(10) Pub. No.: US 2010/0022331 A1
(43) Pub. Date: Jan. 28, 2010

(54) System and Method for Improving Golf Scores

(75) Inventor: David Schneider, Columbus, OH (US)

Correspondence Address: ELEY LAW FIRM CO., 7870 OLENTANGY RIVER RD, SUITE 311, COLUMBUS, OH, 43235, US

(73) Assignee: The Schneider Group Enterprises, LLC DBA Bestcourses.com, Columbus, OH (US)

(21) Appl. No.: 12/177,197

(22) Filed: Jul. 22, 2008

(51) Int. Cl. A63B 69/36; G06F 19/00

(52) U.S. Cl. 473/409; 700/91

(57) ABSTRACT

A method for improving golf scores. Golfing data relating to the performance of a plurality of golfers is gathered and organized into data groups representing predetermined golfer skill levels, the data groups including a set of numerical scores relating to a predetermined set of golfing skillsets. The numerical scores of the golfing data are displayed in tabular form, the columns of the table representing the golfing skillsets and the rows of the table representing the golfer skill levels. A select user's golfing performance data is superimposed upon the displayed table, indicating the user's performance with respect to the golfing skillsets and golfer skill levels and thereby identifying to the user those particular golfing skillsets needing the most improvement.

### FIELD

The present invention relates generally to a system and method for improving golf scores, in particular to a system and method for comparing a player's skill level in various aspects of the game to statistical data representing a predetermined range of other players, thereby identifying to the player areas for improvement.

### BACKGROUND

Golf is a sport in which a player (also termed a “golfer”), using several types of clubs, hits a ball from a teeing ground toward a predetermined hole located at a distance. The ultimate goal of the game is to hit the ball into the hole in the lowest possible number of strokes of the club. The game is played on golf “courses” comprising a series of holes, each consisting of a teeing area, fairway, roughs, sandtraps and unimproved or wooded areas, and a grass green wherein the hole is located. Each hole is assigned a “par” value, which indicates the number of strokes a golfer normally requires to hit the ball from the tee to the hole. A course typically consists of either nine or eighteen holes and is played in a predetermined order.

Each course has a unique design with varying arrangements of fairways, roughs and grades. Consequently, a golfer must develop a number of skills in order to regularly achieve a low score when playing various courses. For example, a player must learn to accurately hit a golf ball a relatively long distance along a fairway and toward the green without the ball falling into a hazard. A player must also develop skill in hitting the ball onto the green in a minimal number of strokes. In addition, the golfer must develop “putting” skill, that is, the ability to hit the ball from the green into the hole in a minimal number of strokes. If the golfer lands in a hazard such as a rough or sandtrap, particular skillsets are required to advance the ball from the hazard to the green.

In evaluating a golfer's performance during a game, a number of criteria are utilized. Firstly, the number of strokes a golfer requires in order to hit the ball from the tee to the hole are compared to the par-value for the hole. A player requiring fewer strokes than par is considered to be “under par,” indicating that the player is performing better than normal for the course.

Another measure is “greens in regulation,” which is a statistic measuring the tee-to-green proficiency of a player. This measure attempts to sum-up, in a single number, a player's performance up to (but not including) putting. A player whose ball reaches the putting surface within par minus two strokes is said to have reached the green in regulation.

An additional performance evaluation criterion is a “sand save.” If a golfer hits the ball into a sand trap and is able to get the ball into the hole in one or two strokes from the sand trap, the player is said to have made a sand save.

Yet another measure of performance is an “up and down.” If the golfer misses the green in regulation and is able to get the ball in the hole in one or two strokes from off the green, the player is said to have made an up and down.

Each of these measures represent learnable skillsets, each of which involve a number of variables such as stances, club selection and swing styles, among other things.

Constant improvement of a player's skillsets is an integral part of the game of golf. To that end, a large number of devices and techniques have been developed that focus upon various facets of the game. For example, U.S. Pat. No. 5,882,269 to Lewis discloses a statistical analysis program for improving golfing performance. However, the method taught by Lewis requires the player to use complex diagrams and input a significant amount of data, including weather conditions. U.S. Pat. No. 6,461,245 to Morgan discloses a system for comparing a golfer's performance to others in the golfer's handicap peer group and an adjacent peer group, but such information is limited in scope and is also not presented in a way to easily identify to the golfer areas for improvement. Other golfing aids require the learning and use of complex devices, such as U.S. Pat. No. 7,037,198 to Hameen-Anttla, which utilizes multi-sport mobile terminals to input data. Such complexity tends to discourage the use of such methods and devices. Accordingly, there is a need for an efficient way to easily record and analyze a golfer's performance and identify to the golfer particular areas of skill improvement upon which to focus.

### SUMMARY

A system and method for improving golf scores is disclosed according to an embodiment to the present invention. Golfing data relating to the performance of a plurality of golfers is gathered and organized into data groups representing predetermined golfer skill levels, the data groups including a set of numerical scores relating to a predetermined set of golfing skillsets. The numerical scores of the golfing data are displayed in tabular form, the columns of the table representing the golfing skillsets and the rows of the table representing the golfer skill levels. A select user's golfing performance data is superimposed upon the displayed table, indicating the user's performance with respect to the golfing skillsets and golfer skill levels, thereby identifying to the user those particular golfing skillsets needing the most improvement.

Another aspect of the present invention is a system for improving golf scores. The system comprises a data repository in communication with a network. A remote terminal is in communication with data repository by means of the network. A dataset is stored in the data repository, the dataset comprising golfing data groups representing predetermined golfer skill levels, the data groups including a set of numerical scores relating to a predetermined set of golfing skillsets. User data is also stored in the data repository, the user data comprising data groups including numerical scores relating to the golfing skillsets defined for the golfing data. A computing device analyzes the golfing data and user data, and communicates the results of the analysis to the remote terminal via the network for display thereon.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is flow diagram showing a method for improving golf scores according to an embodiment of the present invention;

FIG. 2 is a flow diagram showing example sources for data used in connection with the system and method of FIG. 1;

FIG. 3 shows the general arrangement of a system for improving golf scores according to an embodiment of the present invention; and

FIG. 4 is a composite record usable in connection with the system and method of FIGS. 1 and 3.

### DETAILED DESCRIPTION

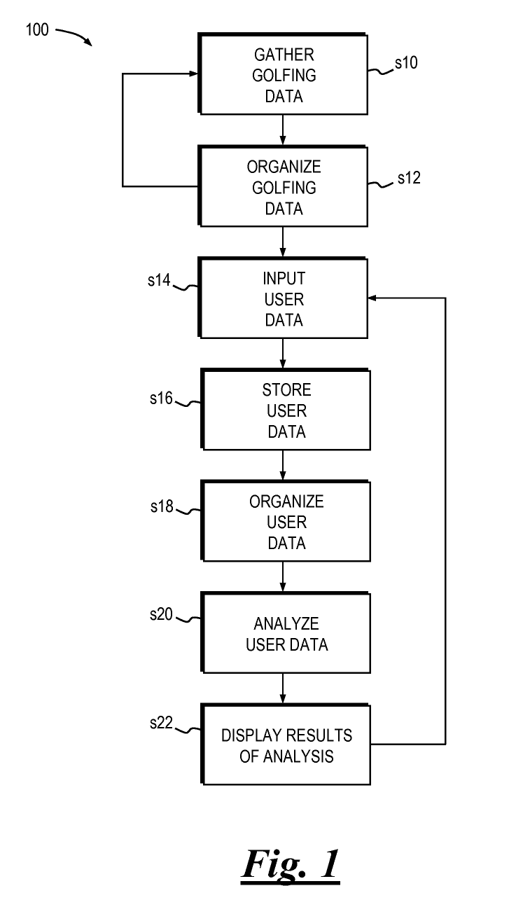

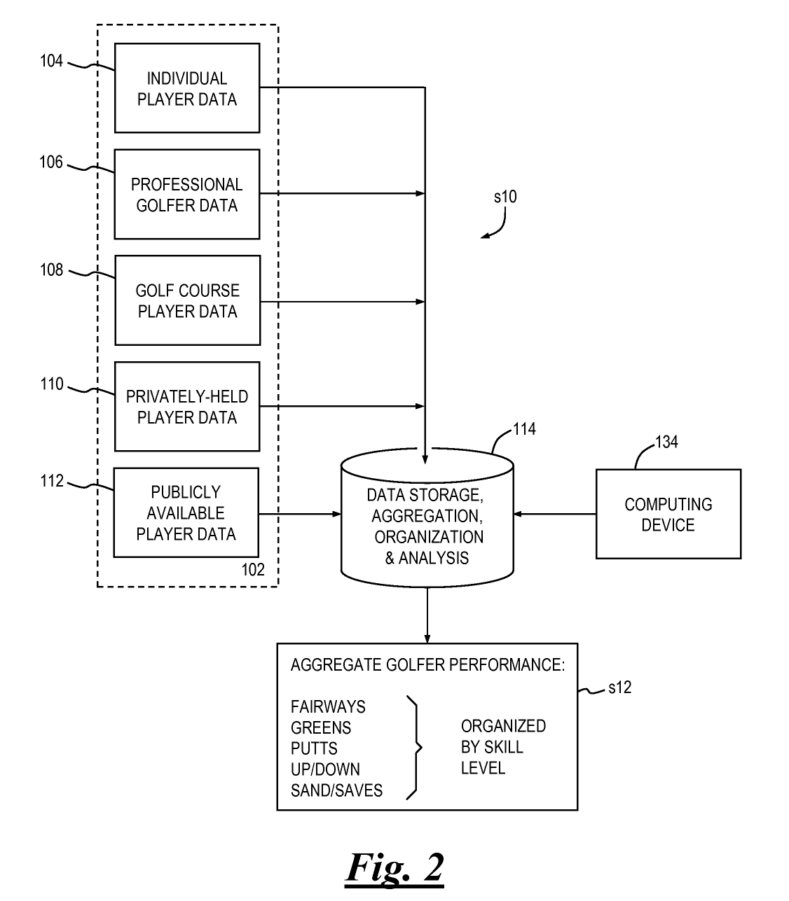

The general arrangement of a method 100 for improving golf scores is shown in FIGS. 1 and 2 according to an embodiment of the present invention. At step s10 of method 100 a dataset comprising an aggregation of golfing performance data 102 for a plurality of golfers is gathered, the golfing data relating to a predetermined set of golfing skills of a statistically significant number of players. As shown in FIG. 2, golfing data 102 may be gathered from a variety sources including, without limitation, individual players 104, professional golfers 106, records of player data at golf courses 108, privately-held player data 110 such as from subscription-based sources, and publicly available player data 112 such as published in printed and/or electronic media, such as the internet. The golfing data 102 are aggregated in a storage repository 114, such as a conventional database or data warehouse.

With continued reference to FIGS. 1 and 2, at step s12 the golfing data 102 are organized into data groups representing predetermined golfing skillsets. Example skillsets include, without limitation, the percentage of time a player hits fairways, greens, up/down and sand/saves. In addition, the number of putts in a game may be tallied. Each data group may be further organized into a plurality of data subgroups representing predetermined golfer skill levels, such as beginner (i.e., “Get to Work”), various handicap ratings, professional levels and superior performance levels (i.e., “Beat the Pros”).

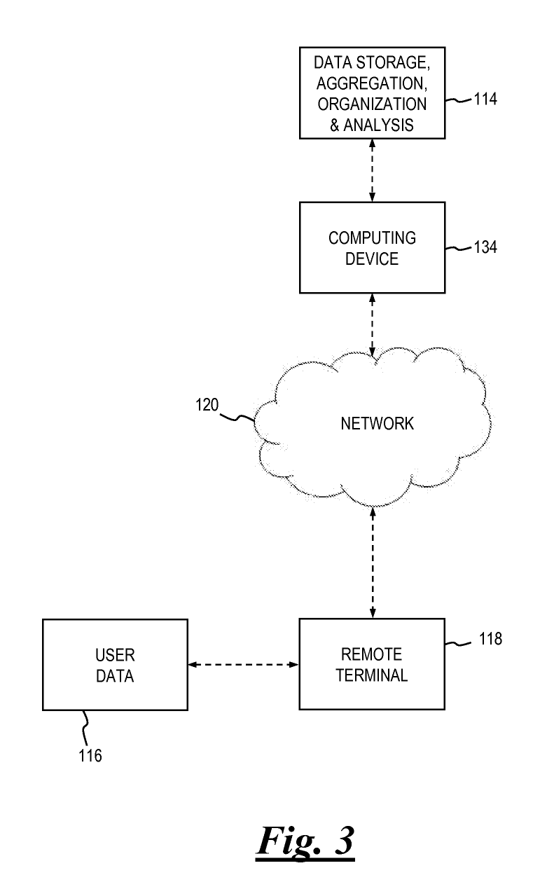

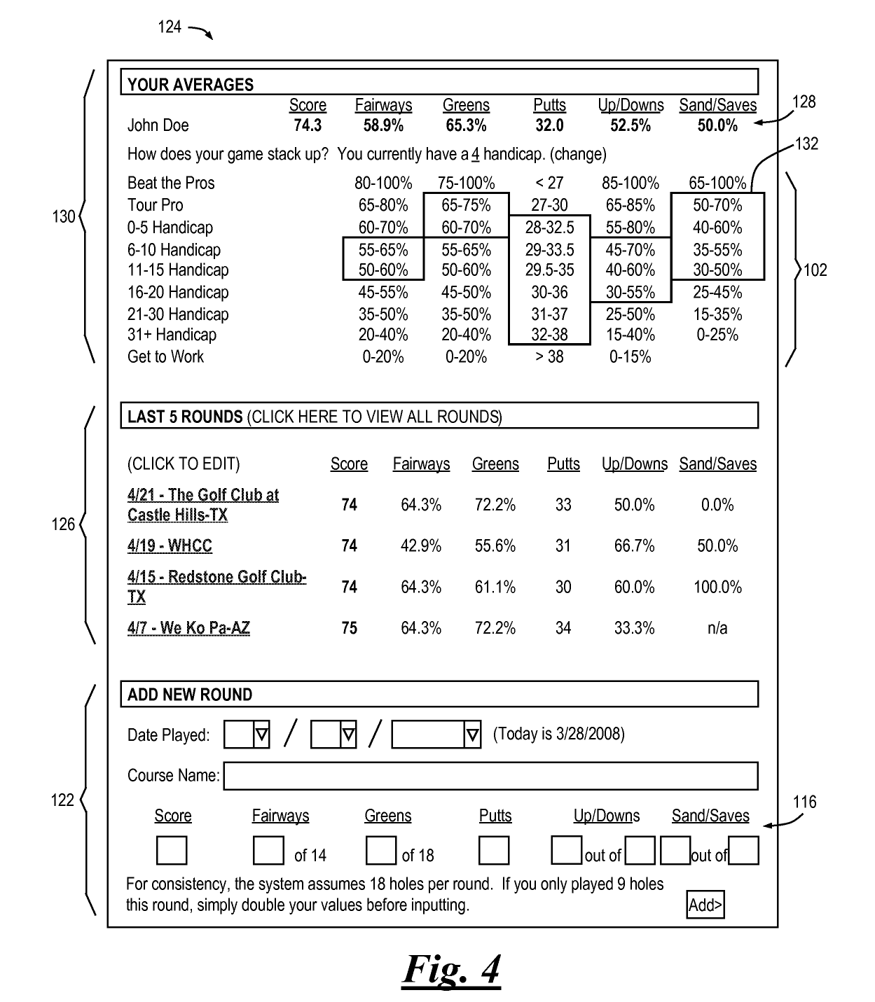

At step s14 a user of system and method 10 inputs user data 116 relating to the user's performance for a specific golf game. In one embodiment of the present invention a user may enter user data 116 electronically with a remote terminal 118 coupled to storage repository 114 by means of a network 120, as shown in FIG. 3. An example input form 122 to facilitate entry of user data 116 is shown in FIG. 4. Input form 122 may be a component of a composite record 124, discussed in greater detail below, or may be separately provided. The user data 116 of step s14 are stored in storage repository 114 at step s16.

At step s18 of FIG. 1 user data 116 is organized in a manner similar to the golfing data 102 at step s12. That is, the data 116 are organized into groups representing predetermined golfing skillsets such as, without limitation, the percentage of time a player hits fairways, greens, up/down and sand/saves. In addition, the number of putts in a game may be tallied as a separate skillset. A summary 126 of the user input data 116 is shown in FIG. 4. Summary 126 may be a component of composite record 124, discussed in greater detail below, or may be separately provided.

At step s20 averages 128 (FIG. 4) of user data 116 are computed and subjected to an analysis comparing the averages to the golfing data 102 organized in accordance with step s12. At step s22 the results of the computation and analysis is displayed in a report 130, as shown in FIG. 4. Report 130 also shows in tabular form the golfing data 102, as organized at step s12. Report 130 further includes a set of overlaid grids 132 comprising boxes or highlighted areas that represent the user's averages 128. Report 130 maybe a component of composite record 124, discussed in greater detail below, or may be separately provided.

With reference now to FIGS. 1-4 together, in operation data 102 are initially gathered, aggregated, stored and organized in accordance with steps s10, s12. Data 102 may be periodically refreshed as new data 104, 106, 108, 110 and 112 become available. A user then utilizes a remote terminal 118 and an input form 122 to provide user data 116 to data storage 114 via a network 120, in accordance with step s14. User data 116 are stored and organized at steps s16, s18. At step s20 user data 116 is subjected to an analysis, comparing user averages 128 to golfing data 102 organized at step s12. At step s22 the results are displayed to the user in the form of a report 130. Report 130 may be displayed upon remote terminal 118.

As shown in FIG. 4, grids as at 132, which reflect the user's average performance data 128, are superimposed upon the organized golfing data 102 of step s12, providing the user with visual feedback indicating how the user's skills compare to that of all other golfers in the dataset 102, ranging from golfers with little experience to professional golfers. Using this information, the user can quickly and easily perceive which skillsets need improvement in order to achieve lower golf scores. For example, in FIG. 4 the user's up/down score is in the range of a 6-20 Handicap, while the user's greens data is in the range of a tour professional and a 0-5 Handicap. Thus, the user's practice, club selection and technique improvement efforts are better spent upon up/down activities rather than greens. The user's performance with regard to other skills, such as fairways, putts and sand/saves may be similarly analyzed in conjunction with up/down and greens to identify to the user (who may be a golfer and/or a golfing instructor reviewing a student's performance) which skillsets are most in need of improvement, ranked and visually displayed on composite record 124.

In some embodiments of the present invention input form 122, summary 126 and report 130 may be displayed upon remote terminal 118 as components of composite record 124. Alternatively, input form 122, summary 126 and report 130 may each be displayed upon terminal 118 as separate screens or displayed in various combinations thereof.

With reference to FIG. 3, in some embodiments of the present invention remote terminal 118 is a personal computer, network 120 is the internet, and data storage 114 is a database coupled to a computing device 134 such as a computer and/or an internet web server. Computing device 134 may be variously configured to manage the data stored in data storage 114, receive golfing data 102 and analyze the golfing data with respect to user data 116, and communicate results of the analysis to remote terminal 118, via network 120, for display thereon. Record 124 of FIG. 4 may be an internet web page displayed upon terminal 118 and having conventional hypertext mark-up language (HTML) data input fields.

While this invention has been shown and described with respect to a detailed embodiment thereof, it will be understood by those skilled in the art that changes in form and detail thereof may be made without departing from the scope of the claims of the invention.

What is claimed is:

1. A method for improving golf scores, comprising the steps of:
gathering golfing data relating to the performance of a plurality of golfers;
organizing the golfing data into data groups representing predetermined golfer skill levels, the data groups comprising a set of numerical scores relating to a predetermined set of golfing skillsets;
displaying in tabular form the numerical scores, the columns of the table representing the golfing skillsets and the rows of the table representing the golfer skill levels; and
superimposing a select user's golfing performance data upon the displayed table, indicating the user's performance with respect to the golfing skillsets and golfer skill levels and thereby identifying to the user those particular golfing skillsets needing the most improvement.

2. The method of claim 1, further comprising the step of gathering golfing data from at least one of individual player data, professional golfer data, golf course player data, privately-held player data and publicly available player data.

3. The method of claim 1 wherein the golfing skillsets include at least one of fairways, greens, putts, up/down and sand/saves.

4. The method of claim 1 wherein the skill levels include at least one of a beginner level, a plurality of handicap levels, a professional level and a superior performance level.

5. The method of claim 1, further comprising the step of providing an input form for a user to enter performance data.

6. The method of claim 1, further comprising the step of providing a summary displaying data provided by the user.

7. The method of claim 1, further comprising the step of displaying the table and the superimposed user data in a report, the report including an average of the user's performance.

8. The method of claim 1, further comprising the step of providing a composite record displaying an input form for a user to enter performance data, a summary displaying data provided by the user, and a report displaying the table and the superimposed user data.

9. A method for improving golf scores, comprising the steps of:
gathering golfing data relating to the performance of a plurality of golfers;
organizing the golfing data into data groups representing predetermined golfer skill levels, the data groups comprising a set of numerical scores relating to a predetermined set of golfing skillsets;
providing data relating to a select user's golfing performance;
storing the user's golfing performance data;
organizing the user data into data groups comprising numerical scores relating to the golfing skillsets defined for the golfing data;
comparing the user's numerical scores to the numerical scores of the golfing data;
displaying in tabular form the numerical scores for the golfing data, the columns of the table representing the golfing skillsets and the rows of the table representing the golfer skill levels; and
superimposing the user's golfing performance data upon the displayed table, indicating the user's performance with respect to the golfing skillsets and golfer skill levels and thereby identifying to the user those particular golfing skillsets needing the most improvement.

10. The method of claim 9, further comprising the step of gathering golfing data from at least one of individual player data, professional golfer data, golf course player data, privately-held player data and publicly available player data.

11. The method of claim 9 wherein the golfing skillsets include at least one of fairways, greens, putts, up/down and sand/saves.

12. The method of claim 9 wherein the skill levels include at least one of a beginner level, a plurality of handicap levels, a professional level and a superior performance level.

13. The method of claim 9, further comprising the step of providing an input form for a user to enter performance data.

14. The method of claim 9, further comprising the step of providing a summary displaying data provided by the user.

15. The method of claim 9, further comprising the step of displaying the table and the superimposed user data in a report, the report including an average of the user's performance.

16. The method of claim 9, further comprising the step of providing a composite record displaying an input form for a user to enter performance data, a summary displaying data provided by the user, and a report displaying the table and the superimposed user data.

17. A system for improving golf scores, comprising:
a data repository in communication with a network;
a remote terminal in communication with the data repository by means of the network;
a dataset stored in the data repository, the dataset comprising golfing data groups representing predetermined golfer skill levels, the data groups including a set of numerical scores relating to a predetermined set of golfing skillsets;
user data stored in the data repository, the user data comprising data groups including numerical scores relating to the golfing skillsets defined for the golfing data; and
a computing device for analyzing the golfing data and user data, and communicating results of the analysis to the remote terminal, via the network, for display thereon.

18. The system of claim 17 wherein the network is the internet.

19. The system of claim 17 wherein the remote terminal is a computer.

20. The system of claim 17 wherein the computing device comprises at least one of a computer and a server.
